(19) United States
(12) Patent Application Publication
(10) Pub. No.: US 2022/0261193 A1
(43) Pub. Date: Aug. 18, 2022

(54) INFORMATION PROCESSING APPARATUS, METHOD, AND NON-TRANSITORY COMPUTER-EXECUTABLE MEDIUM

(71) Applicant: Tsuyoshi SAKAMOTO, Kanagawa (JP)

(72) Inventor: Tsuyoshi SAKAMOTO, Kanagawa (JP)

(73) Assignee: Ricoh Company, Ltd., Tokyo (JP)

(21) Appl. No.: 17/552,763

(22) Filed: Dec. 16, 2021

(30) Foreign Application Priority Data
Feb. 16, 2021 (JP) 2021-022400

(51) Int. Cl. G06F 3/12; G06T 7/00

(52) U.S. Cl. CPC G06F 3/1208; G06F 3/1256; G06T 2207/20228; G06T 7/0002; G06F 3/1225

(57) ABSTRACT

An information processing apparatus includes circuitry configured to display a first image, a second image, a difference image indicating difference between the first image and the second image, and types of the difference.

### CROSS-REFERENCE TO RELATED APPLICATION

This patent application is based on and claims priority pursuant to 35 U.S.C. § 119(a) to Japanese Patent Application No. 2021-022400, filed on Feb. 16, 2021, in the Japan Patent Office, the entire disclosure of which is hereby incorporated by reference herein.

### BACKGROUND

### Technical Field

Embodiments of the present disclosure relate to an information processing apparatus, a method, and a non-transitory computer-executable medium.

### Related Art

Conventionally, a technique for determining whether two images are the same is known. For example, in a field such as commercial printing in which a high-quality printed matter is desired, a user sometimes evaluates whether a quality of a printed matter obtained after a change of a printer driver due to version upgrade is the same as a quality of a printed matter obtained before the change of the printer driver. The user checks an image indicating the difference between the two images, to determine whether the two images are the same.

### SUMMARY

An embodiment of the present disclosure includes an information processing apparatus including circuitry configured to display a first image, a second image, a difference image indicating difference between the first image and the second image, and types of the difference.

Another embodiment of the present disclosure includes a method including displaying a first image, a second image, a difference image indicating difference between the first image and the second image, and types of the difference.

Another embodiment of the present disclosure includes a non-transitory computer-executable storing a program storing instructions which, when executed by a computer, causes the computer to perform a method, the method including displaying a first image, a second image, a difference image indicating difference between the first image and the second image, and types of the difference.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a display example illustrating difference between images, according to the related art;

FIG. 2A and FIG. 2B are diagrams, each illustrating an example of an overall configuration, according to an embodiment of the present disclosure;

FIG. 3 is a block diagram illustrating a hardware configuration of each of an information processing apparatus and an information processing server, according to an embodiment of the present disclosure;

FIG. 4 is a block diagram illustrating a functional configuration of each of the information processing apparatus and the information processing server, according to an embodiment of the present disclosure;

FIG. 5 is a flowchart illustrating an operation of displaying a difference image, according to an embodiment of the present disclosure;

FIG. 6 is an illustration of a display example (Example 1) of the difference image, according to an embodiment of the present disclosure;

FIG. 7 is an illustration of a display example (Example 2) of the difference image, according to an embodiment of the present disclosure;

FIG. 8 is an illustration of a display example (Example 3) of the difference image, according to an embodiment of the present disclosure.

FIG. 9 is an illustration of a display example (Example 4) of the difference image, according to an embodiment of the present disclosure;

FIG. 10 is an illustration of a display example (Example 5) of the difference image, according to an embodiment of the present disclosure; and

FIG. 11 is an illustration of an example of a screen layout, according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

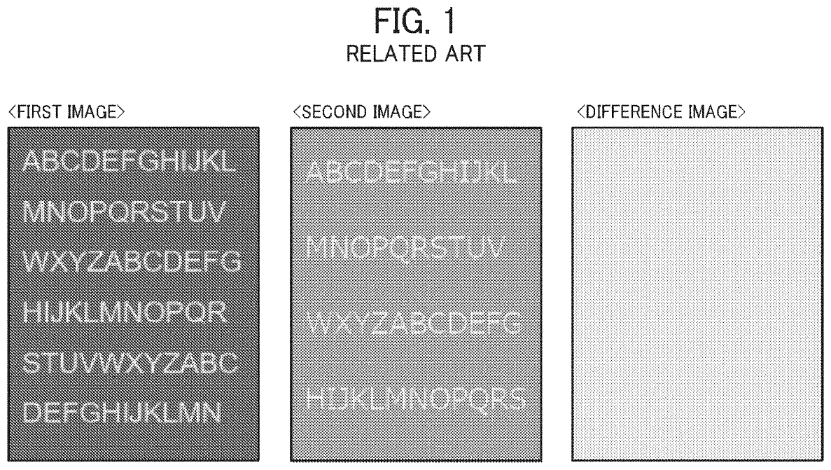

FIG. 1 is a display example illustrating difference between images according to the related art. A “Difference image” indicates difference between a “first image” and a “second image”. It is assumed that the difference between the first image and the second image are classified to two types, one being difference between fonts used in the two images and the other being brightness of background colors of the two images. As illustrated in “Difference Image” of FIG. 1, when such the multiple types of difference are expressed in the same color on one image, one difference (the difference of fonts in the example of FIG. 1) is hidden by the other difference (the difference of brightness of the background colors in the example of FIG. 1). This may cause a drawback such as that a user misses difference between the images that the user should have noticed or that it takes time for the user to check the difference between images.

### Example of Overall Configuration

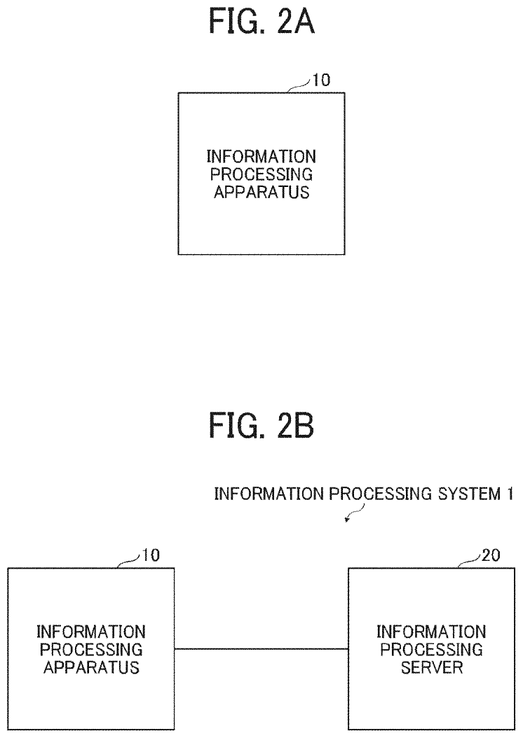

FIG. 2A and FIG. 2B are diagrams, each illustrating an example of an overall configuration, according to an embodiment of the present disclosure. One embodiment of the present disclosure is a system that compares an image output by one system with another image output by another system, displays a difference image indicating difference that a human can visually recognize, and inputs a determination result by a user.

As illustrated in FIG. 2A, in one embodiment of the present disclosure, an information processing apparatus (e.g., a personal computer) 10 compares two images and displays the comparison result on its own display (i.e., a display of the information processing apparatus 10).

As illustrated in FIG. 2B, in an embodiment of the present disclosure, an information processing server 20 compares two images and display the comparison result on a display of the information processing apparatus 10 such as a personal computer. Examples of the information processing server 20 include, but are not limited to, a cloud server including one or more computers. For example, the information processing apparatus 10 transmits two images including a first image and a second image to be compared with each other to the information processing server 20. The information processing server 20 compares the two images and transmits the comparison result to the information processing apparatus 10. The information processing apparatus 10 displays the received comparison result on the display.

Hardware Configuration:

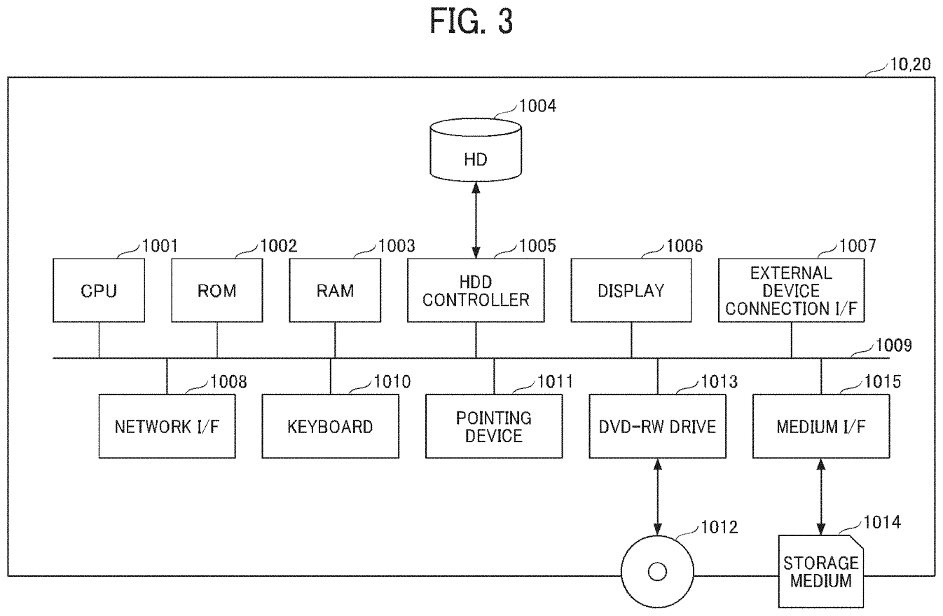

FIG. 3 is a block diagram illustrating a hardware configuration of each of the information processing apparatus 10 and the information processing server 20, according to an embodiment of the present disclosure.

As illustrated in FIG. 3, each of the information processing apparatus 10 and the information processing server 20 is implemented by a computer. As illustrated in FIG. 3, the computer includes a central processing unit (CPU) 1001, a read only memory (RONI) 1002, a random access memory (RAM) 1003, a hard disk (HD) 1004, a hard disk drive (HDD) controller 1005, a display 1006, an external device connection interface (I/F) 1007, a network I/F 1008, a bus line 1009, a keyboard 1010, a pointing device 1011, a digital versatile disk rewritable (DVD-RW) drive 1013, and a medium I/F 1015.

The CPU 1001 controls overall operation of each of the information processing apparatus 10 and the information processing server 20. The ROM 1002 stores a program such as an initial program loader (IPL) to boot the CPU 1001. The RAM 1003 is used as a work area for the CPU 1001. The HD 1004 stores various data such as a program. The HDD controller 1005 controls reading or writing of various data from or to the HD 1004 under control by the CPU 1001. The display 1006 displays various information such as cursors, menus, windows, characters, or images. The external device connection I/F 1007 is an interface that connects each of the information processing apparatus 10 and the information processing server 20 to various external devices. Examples of the external devices include, but are not limited to, a universal serial bus (USB) memory and a printer. The network I/F 1008 is an interface that enables each of the information processing apparatus 10 and the information processing server 20 to perform data communication through a communication network. The bus line 1009 is, for example, an address bus or a data bus, which electrically connects the components illustrated in FIG. 3, such as the CPU 1001.

The keyboard 1010 is an example of an input device including a plurality of keys for inputting characters, numerical values, various instructions, and the like. The pointing device 1011 is an example of an input device that allows a user to select or execute a specific instruction, select an object for processing, or move a cursor being displayed. The DVD-RW drive 1013 controls reading or writing of various data from or to a DVD-RW 1012, which is an example of a removable storage medium. In another example, a digital versatile disk-recordable (DVD-R) can be used as the removal storage medium, in alternative to the DVD-RW 1012. The medium T/F 1015 controls reading or writing of data from or to a storage medium 1014 such as a flash memory.

Functional Configuration:

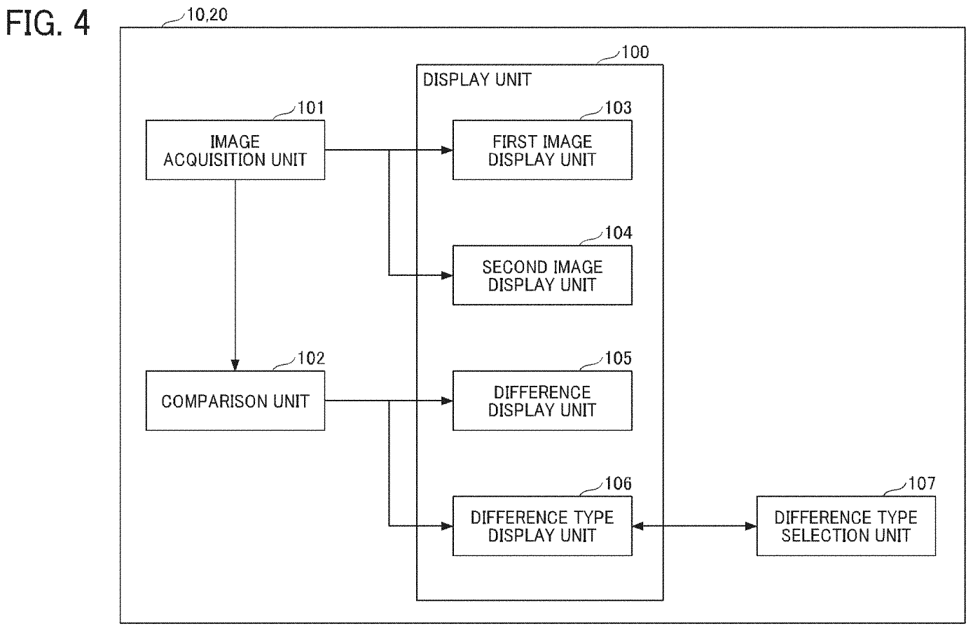

FIG. 4 is a block diagram illustrating a functional configuration of each of the information processing apparatus 10 and the information processing server 20, according to an embodiment of the present disclosure. Each of the information processing apparatus 10 and the information processing server 20 include an image acquisition unit 101, a comparison unit 102, a first image display unit 103, a second image display unit 104, a difference display unit 105, a difference type display unit 106, and a difference type selection unit 107. Each of the information processing apparatus 10 and the information processing server 20 executes the program to function as the image acquisition unit 101, the comparison unit 102, the first image display unit 103, the second image display unit 104, the difference display unit 105, the difference type display unit 106, and the difference type selection unit 107. The first image display unit 103, the second image display unit 104, the difference display unit 105, and the difference type display unit 106 may be referred to collectively as a “display unit 100”.

The image acquisition unit 101 acquires two images, i.e., the first image and the second image to be compared with each other. Note that the image acquisition unit 101 acquires the first image and the second image stored in a desired storage device. For example, the first image and the second image are images represented by CMYK (four components of cyan, magenta, yellow, and black).

The comparison unit 102 compares the first image and the second image with each other, to generate an image indicating difference between the first image and the second image. In the following description, such an image indicating difference between the first image and the second image may be referred to as a “difference image”. The comparison unit 102 can generate the image (the difference image) indicating the difference between the first image and the second image for each of types of difference.

A description is now given of the types of difference. The types of difference include any types of difference between the first image and the second image. Examples of the types of difference include, but are not limited to, include difference between fonts used in the first image and the second image, difference of brightness of background colors between the first image and the second image, which result from a version upgrade of a printer driver, for example.

A description is now given of generation of the difference image. For example, the 3 comparison unit 102 compares a pixel value of the first image and a pixel value of the second image for each pixel. Further, the comparison unit 102 determines types of difference between the first image and the second image based on the comparison result for each pixel. Furthermore, the comparison unit 102 generates the difference image for each of the types of difference.

The first image display unit 103 displays the first image acquired by the image acquisition unit 101.

The second image display unit 104 displays the second image acquired by the image acquisition unit 101.

The difference display unit 105 displays the image (the difference image) generated by the comparison unit 102, the difference image indicating difference between the first image and the second image.

For example, in response to receiving a user's selection of a particular type of difference from the types of difference, the difference display unit 105 can display the difference image of the selected type of difference.

For example, the difference display unit 105 displays an image (difference image) indicating difference using different colors for the different types of difference, respectively.

For example, the difference display unit 105 displays an image (difference image) indicating difference, the difference image indicating a part wire the difference occurs for each of types of difference.

For example, the difference display unit 105 alternately displays the first image and the second image at certain time intervals, e.g., every 0.5 seconds, which are relatively short time intervals, to display the difference image indicating the difference.

The difference type display unit 106 displays a type of difference between the first image and the second image. Specifically, the difference type display unit 106 displays all types of difference between the first image and the second image determined by the comparison unit 102.

The difference type selection unit 107 selects a difference image to be displayed based on the type of difference selected by the user. Specifically, the user selects a desired type of difference from the displayed types of differences. In response to receiving the user's selection, the difference type selection unit 107 selects the difference image of the difference type selected by the user from the difference images generated respectively fix the difference types by the comparison unit 102.

Operation:

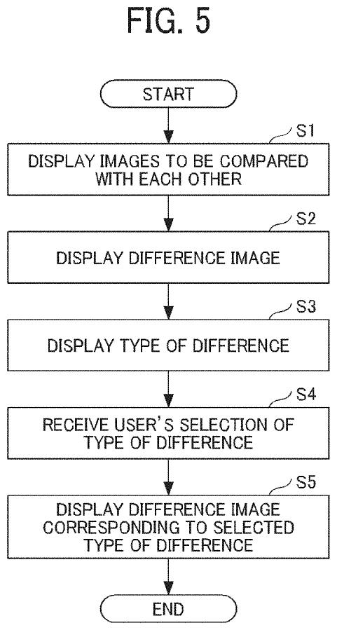

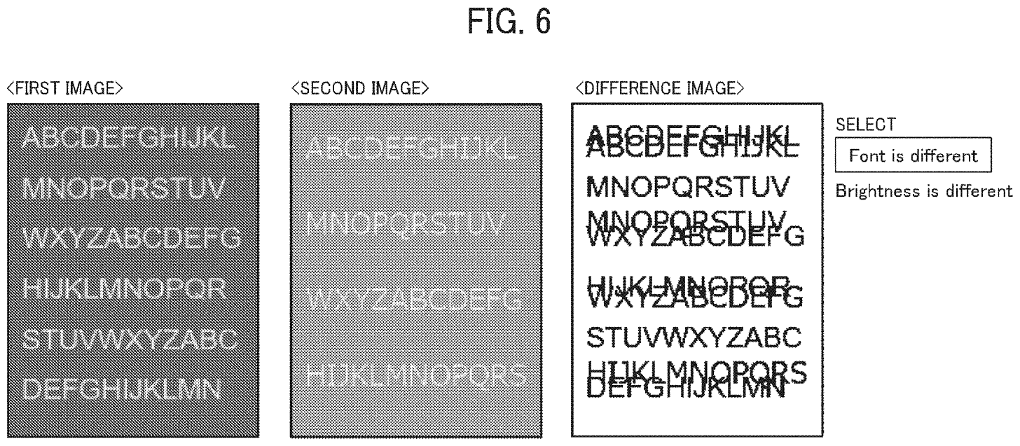

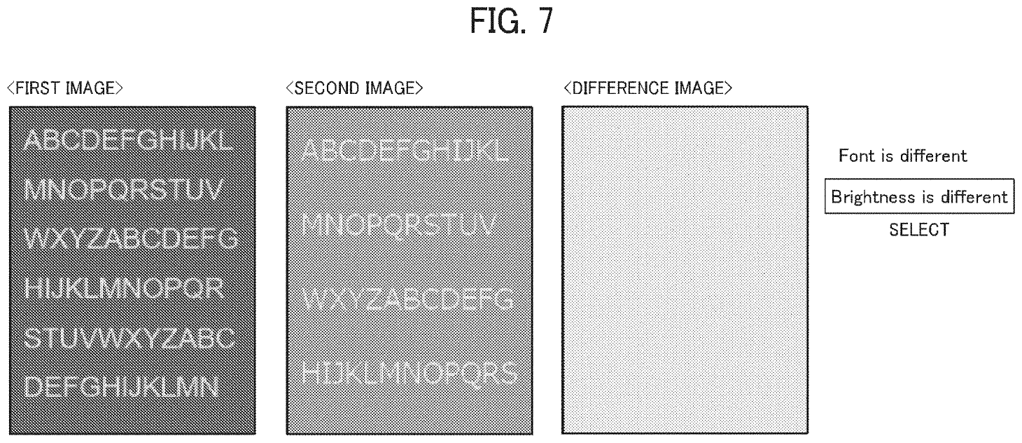

FIG. 5 is a flowchart illustrating an operation of displaying the difference image (in cases as illustrated in FIG. 6 and FIG. 7), according to an embodiment of the present disclosure.

In step S1, the display unit 100 displays images to be compared with each other. Specifically, the first image display unit 103 displays the first image acquired by the image acquisition unit 101. Further, the second image display unit 104 displays the second image acquired by the image acquisition unit 101.

In step S2, the display unit 100 displays a difference image. Specifically, the difference display unit 105 displays an image (the difference image) indicating difference between the first image and the second image.

In step S3, the display unit 100 displays types of the difference. Specifically, the difference type display unit 106 displays all types of difference between the first image and the second image.

In step S4, the difference type selection unit 107 selects a difference image to be displayed based on a particular type of difference selected by the user.

In step S5, the display unit 100 displays the difference image. Specifically, the difference display unit 105 displays the difference image corresponding to the type of difference selected by the user in step S4.

The processes of S4 and S5 are repeated each time the user selects the type of difference.

### DISPLAY EXAMPLES

A description is now given of display examples of an image (difference image) indicating difference between the first image and the second image with reference to FIG. 6 to FIG. 10.

FIG. 6 is an illustration of a display example (Example 1) of the difference image, according to an embodiment of the present disclosure. An image on the left side of the page in FIG. 6 is the first image, an image in the center of the page in FIG. 6 is the second image, and an image on the right side of the page in FIG. 6 is the difference image. Example 1 is an example case in which the user operates the keyboard 1010 or the pointing device 1011 to select “font” from the types of difference. In response to the user's selection, the difference display unit 105 displays a difference image indicating only the difference in font among the difference between the first image and the second image. Thus, in Example 1, the user can check only the difference of the desired type (font in this example).

FIG. 7 is an illustration of a display example (Example 2) of the difference image, according to an embodiment of the present disclosure. An image on the left side of the page in FIG. 7 is the first image, an image in the center of the page in FIG. 7 is the second image, and an image on the right side of the page in FIG. 7 is the difference image. Example 2 is an example case in which the user operates the keyboard 1010 or the pointing device 1011 to select “brightness of background color” from the types of difference. In response to the user's selection, the difference display unit 105 displays a difference image indicating only the difference in brightness of a background color among the difference between the first image and the second image. Thus, in Example 2, the user can check only the difference of the desired type (the brightness of the background color in this example).

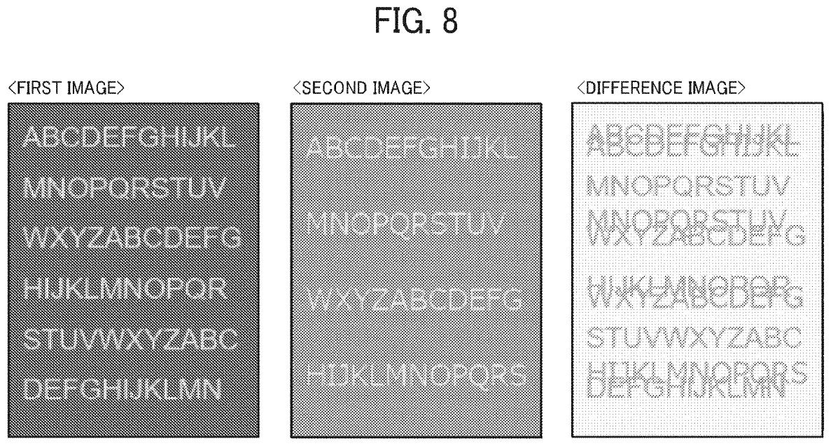

FIG. 8 is an illustration of a display example (Example 3) of the difference image, according to an embodiment of the present disclosure. An image on the left side of the page in FIG. 8 is the first image, an image in the center of the page in FIG. 8 is the second image, and an image on the right side of the page in FIG. 8 is the difference image. In Example 3, the difference display unit 105 displays an image (difference image) indicating difference using different colors for the different types of difference, respectively. Thus, in Example 3, the user can check the difference for each of the types of difference by color.

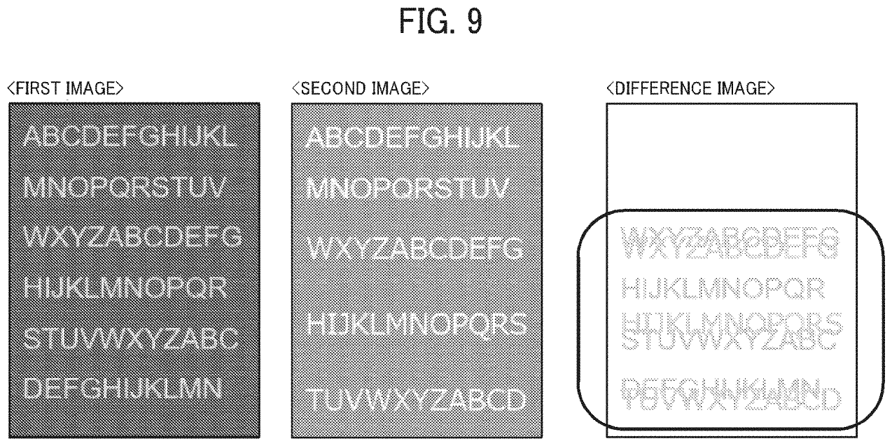

FIG. 9 is an illustration of a display example (Example 4) of the difference image, according to an embodiment of the present disclosure. An image on the left side of the page in FIG. 9 is the first image, an image in the center of the page in FIG. 9 is the second image, and an image on the right side of the page in FIG. 9 is the difference image. In Example 4, the difference display unit 105 displays an image (difference image) indicating difference for each of the types of difference, the difference image including, for example, a frame that surrounds a part where the difference occurs. Thus, in Example 4, the user can check the difference for each of the types of difference by an area.

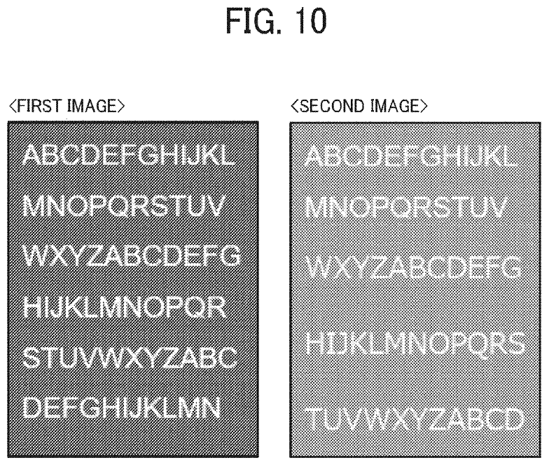

FIG. 10 is an illustration of a display example (Example 5) of the difference image, according to an embodiment of the present disclosure. An image on the left side of the page in FIG. 10 is the first image, and an image on the right side of the page in FIG. 10 is the second image. In Example 5, the difference display unit 105 alternately displays the first image and the second image at certain time intervals, e.g., every 0.5 seconds, which are relatively short time intervals, to display an image (difference image) indicating difference. When alternately displaying the first image and the second image at the relatively short time intervals, the display of an area in which the first image and the second image are identical does not change, while the display of an area in which the first image and the second image are different from each other changes. This enables the user to check the difference between the first image and the second image by persistence of vision.

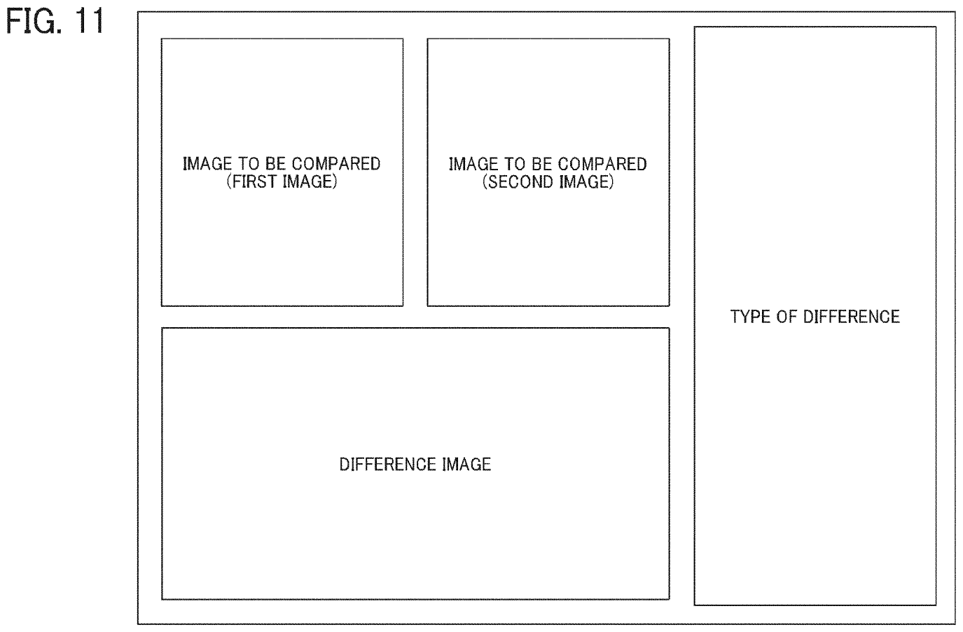

FIG. 11 is an illustration of an example of a screen layout, according to an embodiment of the present disclosure. In one embodiment of the present disclosure, the display unit 100 displays an image to be compared (the first image), another image to be compared (tie second image), the difference image, and the type of difference in a layout as illustrated in FIG. 11. This layout allows the user to select a desired type of difference from multiple types of difference being displayed.

Variations:

A description is now given of other embodiments.

In an embodiment of the present disclosure, the display unit 100 displays the difference image as being superimposed on the first image or the second image. This enables the user to check a part in which the first image or the second image and the difference image are different from each other.

In one embodiment of the present disclosure, the display unit 100 displays only a part in which difference between the first image and the second image occurs. This enables the user to check only the part in which the difference occurs.

In one embodiment of the present disclosure, the display unit 100 displays another difference image having a difference similar to the difference between the first image and the second image. This enables the user to distinguish between the first image and the second image in view of another difference image.

In one embodiment of the present disclosure, in response to a user's selection of a desired type of difference, the display unit 100 displays an image indicating difference of the selected type of difference between the first image and the second image, and displays another difference image having a difference similar to the difference of the selected type of difference between the first image and the second image. This enables the user to distinguish between the first image and the second image in view of another difference image.

As described above, according to an embodiment of the present disclosure, difference between the first image and the second image is displayed in a manner that one can recognize what kind of difference the difference is. Accordingly, the difference between the first image and the second image is not buried in other difference and clearly presented to the user.

According to conventional technologies, in a case that there are multiple types of difference between two images, it is difficult to clearly indicate the difference between the two images to a user.

According to an embodiment of the present disclosure, the efficiency of an operation of checking difference between images is improved.

Each of the functions of the described embodiments may be implemented by one or more processing circuits or circuitry. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An information processing apparatus, comprising circuitry configured to
display a first image, a second image, a difference image indicating difference between the first image and the second image, and types of the difference.

2. The information processing apparatus of claim 1, wherein
the difference image displayed by the circuitry indicates the difference in one of the types of the difference that is selected.

3. The information processing apparatus of claim 1, wherein
the difference image displayed by the circuitry indicates the difference between the first image and the second image in different colors for the types of the difference, respectively.

4. The information processing apparatus of claim 1, wherein
the difference image displayed by the circuitry indicates a part where the difference occurs for each of the types of the difference.

5. The information processing apparatus of claim 1, wherein
the circuitry alternately displays the first image and the second image at certain time intervals, to display the difference image.

6. The information processing apparatus of claim 1, wherein
the circuitry displays the difference image as being superimposed either one of the first image and the second image.

7. The information processing apparatus of claim 1, wherein
the circuitry displays only a part where the difference between the first image and the second image occurs.

8. The information processing apparatus of claim 1, wherein
the circuitry displays another difference image indicating another difference between the first image and the second image, said another difference being similar in degree of difference to the difference between the first image and the second image.

9. The information processing apparatus of claim 8, wherein
the difference image displayed by the circuitry in response to a selection of a particular type of difference from the types of the difference indicates the difference of the particular type of difference between the first image and the second image, and
said another difference image has difference similar in degree of difference to the difference of the particular type of difference between the first image and the second image.

10. A method comprising
displaying a first image, a second image, a difference image indicating difference between the first image and the second image, and types of the difference.

11. A non-transitory computer-executable storing a program storing instructions which, when executed by a computer, causes the computer to perform a method, the method comprising displaying a first image, a second image, a difference image indicating difference between the first image and the second image, and types of the difference.
